(19) United States
(12) Patent Application Publication
(10) Pub. No.: US 2009/0157853 A1
(43) Pub. Date: Jun. 18, 2009

(54) SYSTEMS, METHODS AND COMPUTER PROGRAM PRODUCTS FOR CAPACITY ON-DEMAND SERVER MECHANISM FOR SEAMLESS 3D VIRTUAL WORLDS

(75) Inventor: Jun Doi, Yokohama (JP)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/958,553

(22) Filed: Dec. 18, 2007

(51) Int. Cl. G06F 15/177

(52) U.S. Cl. 709/220

(57) ABSTRACT

Systems, methods and computer program products for a capacity on-demand server mechanism for seamless 3D virtual worlds. Exemplary embodiments include a method including, partitioning the 3D world into the domains, associating each of the domains with a server relating each of the partitioned domains to nodes of a graph, storing a list of edges adjacent the domain, storing each list of edges associated with each of the servers in a central management server, performing a node split, performing an edge contraction, transferring data among the domains, determining an effect in the one or more of the domains in response to the interaction of an object with the domains, determining a location of the object in the domains by analyzing a pointer associated with each of the edges and updating each of the servers associated with the domains through which the object has interacted.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to on-demand servers, and particularly to systems, methods and computer program products for a capacity on-demand server mechanism for seamless 3D virtual worlds.

2. Description of Background

The seamless virtual world, or the zone-less virtual world, is to move around the vast virtual world. In such a seamless virtual world, natural movement without interruption is possible as in the real world, and one can feel the vast expanse of the world. However, it is necessary to devise means of object management and display when realizing seamless movement, as there must be an enormous amount of geographic configurations and objects constructing the virtual world. Especially in online virtual worlds (such as massively multiplayer online role-playing games (MMORPGs) and Second Life), several clients are to be managed simultaneously in a seamless virtual world.

In most current MMORPGs (and Second Life), the virtual world are not seamless but divided into several small domains (zones, maps, islands, etc.). When one or several domains are managed by a single server, the burden is to some extent reduced, making it more easily managed by both sides (managers and clients). Whereas, in typical current MMORPGs, the screen goes blank once when reconnecting to another server (so-called ‘zoning’) and moving to a different domain, which can prevent players from feeling the width of the virtual world and experiencing truly free movement. Moreover, there may be some domains that the players flock to and the loads exceed capacity as each server is fixed to one domain, and there may be other domains that are not popular at all. While the loads may be reduced by restricting the number of objects to be included in the domain, such restrictions limit developers' freedom when designing a virtual world.

Some MMORPGs have already realized seamless virtual worlds (World of Warcraft, Lineage II, etc.). They have divided the space of the virtual world itself into several small domains, and each domain is managed by an individual server. Though the servers can pass the different data which are necessary for shifting, display, and so on, this method still has not solved the issues of the concentration or abatement of the loads.

### SUMMARY OF THE INVENTION

Exemplary embodiments include a method including determining a number of domains into which a 3D virtual world can be divided in response to an available number of servers in the distributed computer system to support the number of domains, partitioning the 3D world into the domains, associating each of the domains with a server in the distributed computer system relating each of the partitioned domains to nodes of a graph, storing a list of edges adjacent the domain, storing each list of edges associated with each of the servers in a central management server associated with the distributed computer system, performing a node split on one or more of the nodes by inserting an edge within each of the one or more nodes thereby splitting each of the one or more nodes, performing an edge contraction by merging two or more adjacent nodes, transferring data among the domains in response to an interaction of an object in the 3D virtual world with one or more of the domains, determining an effect in the one or more of the domains in response to the interaction of the object with the one or more of the domains, determining a location of the object in the one or more of the domains by analyzing a pointer associated with each of the edges and updating each of the servers associated with the domains through which the object has interacted.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which provides systems, methods and computer program products that allow the number of servers managing the virtual world can be dynamically increased or decreased, so that the number of servers can be scalable and increased and the issues of load concentration and abatement can be flexibly handled. Therefore, the quality of service can be improved. The graph topology also enables the optimization of data communication among the small domain servers. Giving attribute values to the nodes and edges of the graph structure, the minimum information required can be defined by tracing the nodes of graph. It then optimizes the handlings to consolidate the data necessary for the display for clients, sending over the updated information from clients to required small domains. The domain can become a scalable server even within the virtual world of domain server styles, extending beyond the realm of seamless virtual worlds.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1a illustrates a topology and graph structure of space partitioning in accordance with exemplary embodiments;

FIG. 1b illustrates a topology and graphical structure of a virtual world in accordance with exemplary embodiments;

FIG. 2a illustrates a topology and graph structure a small domain partitioned by a node split operator in accordance with exemplary embodiments;

FIG. 2 b illustrates a topology and graph structure a small domain merged by an edge contraction operator in accordance with exemplary embodiments;

FIG. 3 illustrates a processing flow of a virtual world server by graph in accordance with exemplary embodiments;

FIG. 4 illustrates a block diagram of a data structure for nodes and edges of a graph in accordance with exemplary embodiments;

FIG. 5 illustrates a block diagram of a server configuration diagram of a virtual world in accordance with exemplary embodiments;

FIG. 6 illustrates a hierarchal graph structure in accordance with exemplary embodiments;

FIG. 7 illustrates a topology aid graphical structure for multiple node division in accordance with exemplary embodiments;

FIG. 8 illustrates a topology and graphical structure for multiple node division with a child graph in accordance with exemplary embodiments;

FIG. 9 illustrates block diagram of an example of server addition by node split in accordance with exemplary embodiments; and

FIGS. 10a-10c illustrate block diagrams of an example of association and transfer of data to be processed and a graph topology update in accordance with exemplary embodiments.

The detailed description explains the preferred embodiments of the invention, together with advantages and features, by way of example with reference to the drawings.

### DETAILED DESCRIPTION OF THE INVENTION

In exemplary embodiments, systems, methods and computer products for the connections between the small domains of a 3D virtual world are described by drawing the topology of the 3D virtual world with a graph structure. The nodes of the graph represent the servers managing each small domain, and the nodes are connected with edges as their adjacency relationship. In exemplary embodiments, there are two topology operators of the graph, node split and edge contraction. With these two topology operators, the number of servers managing the virtual world can be dynamically increased or decreased, so that the number of servers can be scalable and increased and the issues of load concentration and abatement can be flexibly handled. Therefore, the quality of service can be improved. The graph topology also enables the optimization of data communication among the small domain servers. Giving attribute values (such as distance, width, visibility, sound insulation, etc.) to the nodes and edges of the graph structure, the minimum information required can be defined by tracing the nodes of graph. It then optimizes the handlings to consolidate the data necessary for the display for clients, sending over the updated information from clients to required small domains. With the systems, methods and computer program products described herein, the domain can become a scalable server even within the virtual world of domain server styles, extending beyond the realm of seamless virtual worlds.

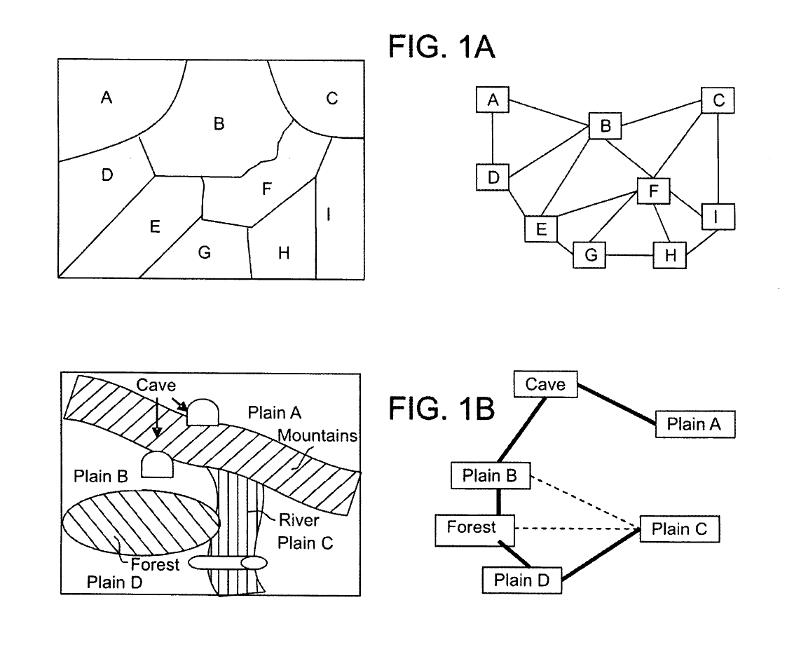

In exemplary embodiments, at first, the 3D virtual world is partitioned into small domains for the designer's convenience. Relating those partitioned small domains to nodes of a graph, adjacent small domains are connected by edges, and the graph shown in FIG. 1a is created. (Although the chart is shown in 2D for description, the same topology can be drawn in 3D space). When considering the designer's convenience, it is easier to realize natural movement if the boundary divisions are used as joints to divide into small domains, as shown in FIG. 1b.

In FIG. 1b, the parts that are movable among small domains are shown by solid line edges, while those visible among small domains are depicted by the dash line edges. Mountain ranges are an unmovable domain, and the objects on the opposite side cannot be seen if the mountain is sufficiently high. Whereas, if the river is narrow, the other side is visible. Therefore, information must be exchanged by connecting edges. In the same way, if a house with several rooms is to be created, it is convenient to divide small domains with reference to walls and floors, and then set the restrictions between domains. For example, outside is visible from the second floor window but one cannot go outside from there, or the wall is soundproof and no sound can be heard from the other side (sound effects or chat cannot be heard). Thus, by giving the edges attributes such as movable, visible, not soundproof, the necessary data to be exchanged between the adjacent domains can be defined. Based on the graph stricture with partitioned domains including the designer's intentions, the domains can be dynamically increased or decreased.

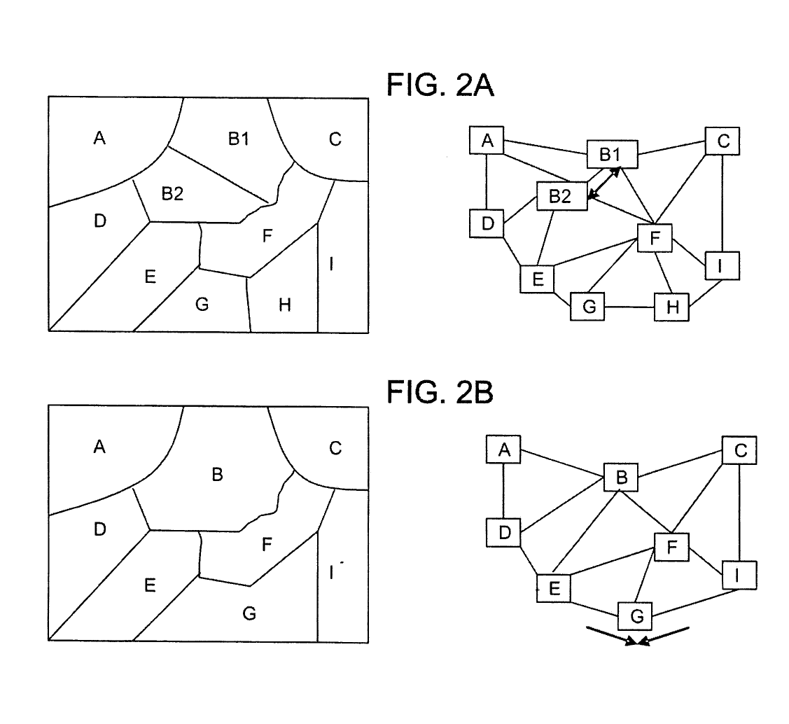

The node split of FIG. 2a is to split the node of the graph into two nodes and insert an edge in-between them. At the same time, the virtual world's small domain is divided in two and allocated to each node. Then add a new server and the server manages new small domain. The node split is not topologically unique operation defined on the graph without geometrical information. So when conducting this graph, the adjacent relations should be reconnected according to the geometrical information of small domains.

In exemplary embodiments, the edge contraction of FIG. 2b is to delete an edge and merge two nodes together. At the same time, treat two virtual world spaces as one and allocate them to one node. Then delete the server and put it on standby. This operation can be defined topologically unique on the graph.

In exemplary embodiments, the systems, methods and computer products described herein divide as much as possible according to the designer's intentions for effective manipulations, in order to reduce the processing time and to divide domains and spread the parts that may have heavier loads.

In exemplary embodiments, one of the defining methods of graph data that includes these topology operations is the “progressive meshes.”

While the first number of small domains is decided by the server resources, if a certain number of extra servers are prepared and kept for the load concentration, nodes are divided and the processing are dispersed when the load exceeds the threshold value. In case the prepared servers are not sufficient, the adjacent two domains without much load are to be merged by edge contraction operation and servers are to be allocated to the heavily loaded parts. After the concentration of loads begins to quiet down, the systems, methods and computer program products described here perform the edge contraction again and keep the servers on stand-by.

Thus, to spread the manipulations of a seamless virtual world, data communication between the small domain servers is necessary. As long as the space is not completely closed by walls, and the spaces are in sequence, the data should be passed at the boundary of domains. For example, if one object or avatar is moved, all the servers that can see the object/avatar should know its new location. Additionally, if the object or avatar has moved beyond the domains, the attributed server should be changed.

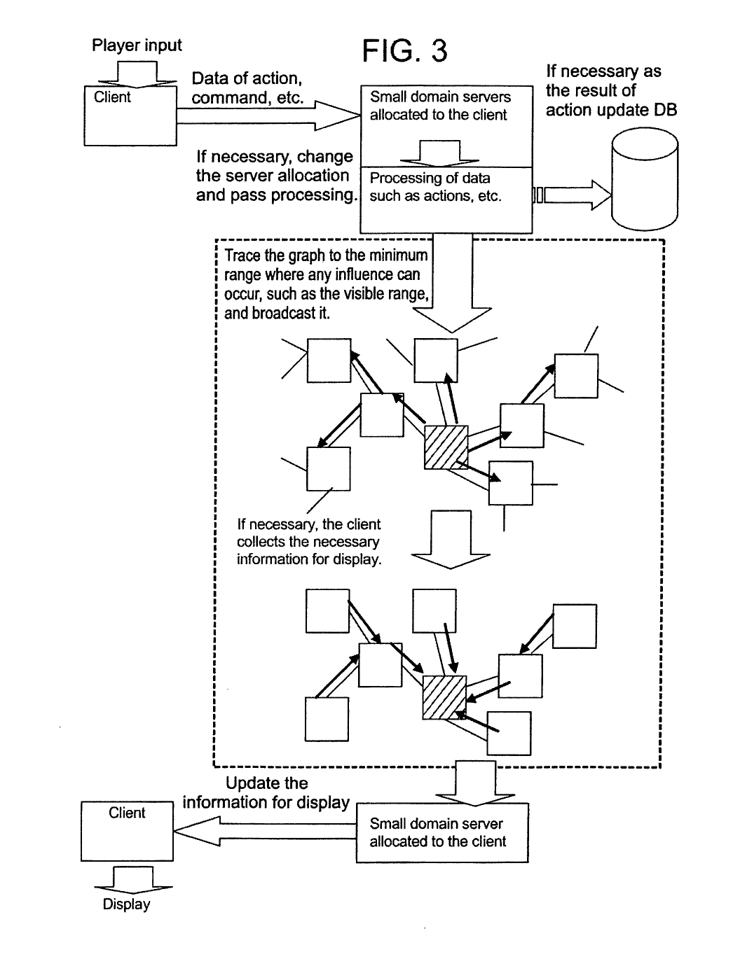

In exemplary embodiments, clients should be given the impression that one server is managing one seamless virtual world. Clients communicate with the small domain server that they belong to, and the small domain server returns the necessary information to them. As shown in FIG. 3, if the client inputs something (for example, something has moved), the data and command that relate to the movement are sent to the small domain server. The small domain server conducts the processing for the command. If there is any information that has to be updated at this point, notify the updates (in cases of damage or receipt of items). If moving to and entering the next small domain, notify the server changes when passing the processing and returning the processing to the client.

In addition, the small domain server responds to the client's manipulation and notifies of the change if there is likely to be any effect on the adjacent small domains. The consistency of the data, such as the movements of objects and avatars, is to be ensured for the display use by other clients. Then tracing the nodes on the graph to the adjacent nodes and beyond, to notify of the change to the nodes within the visible range of the object or avatar. Refer to the attributes of the edges, and if they are invisible, the node does not have to be notified. The communication processing can be optimized by tracing the nodes on the graph and limiting the nodes to be notified.

In exemplary embodiments, the information necessary for clients to display should also be collected from the adjacent nodes. Such information can be collected by tracing the nodes on the graph in reverse from the notification. However, although information processing is required when the updated data is to be collected for an individual client, the information from other clients has been updated by the above notification processing; as a result, each small domain server has already received such information in many cases. Synchronizing the information, send the client on the basis of the information at that time.

As a means of realizing the exemplary embodiments described herein, an example of implementing the data structure of a graph so as to dynamically manage a server is shown alongside an example of dynamically deleting and adding servers.

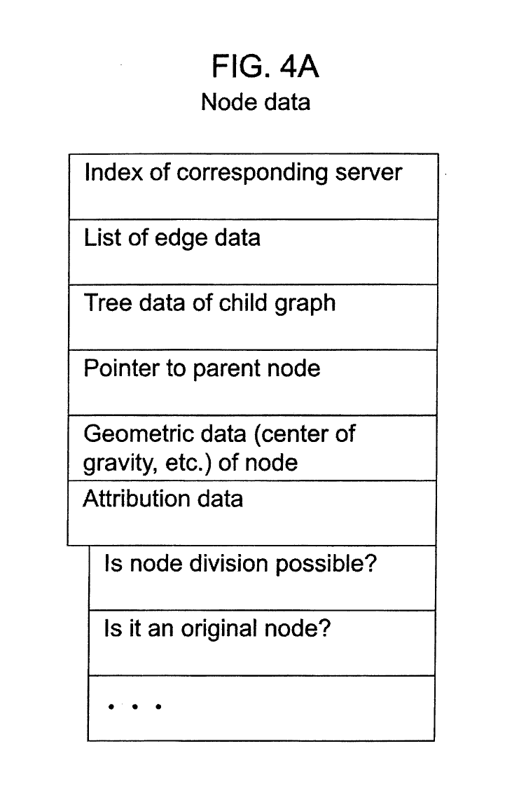

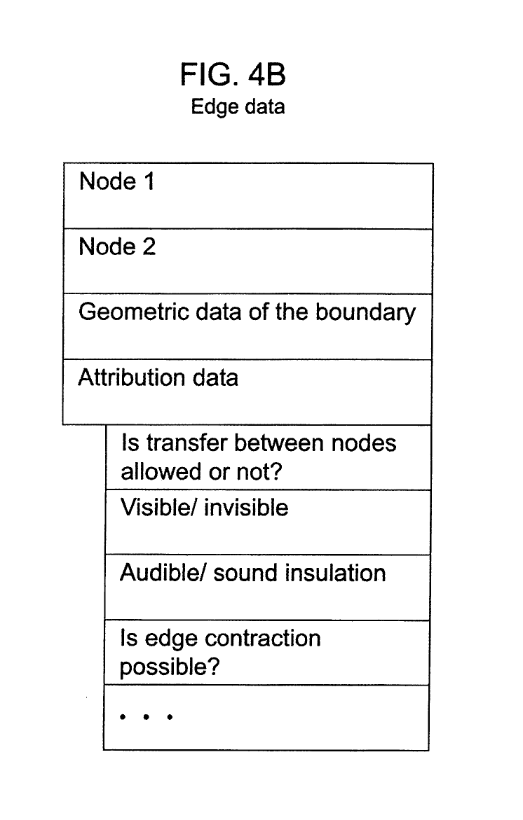

With regard to the data structure for managing a server, a graph stricture is employed to preserve a topology for connections between servers. Specifically, by dividing a three-dimensional virtual world into arbitrary numbers of small areas, the small areas are made to be nodes, and a graph structure is employed with a boundary of each small area set as an edge. The node and server are then corresponded one by one. When looking at the three-dimensional virtual world divided into small areas as a Voronoi diagram, the data stricture becomes its dual graph. (See FIG. 1a) In general, such a graph can be expressed as triangular meshes (or tetrahedral meshes in 3D space). However, the boundary need not necessarily be a plane (or straight line in 2D); it could also be a curved surface (curved line). FIG. 4 shows data structure of node and edge.

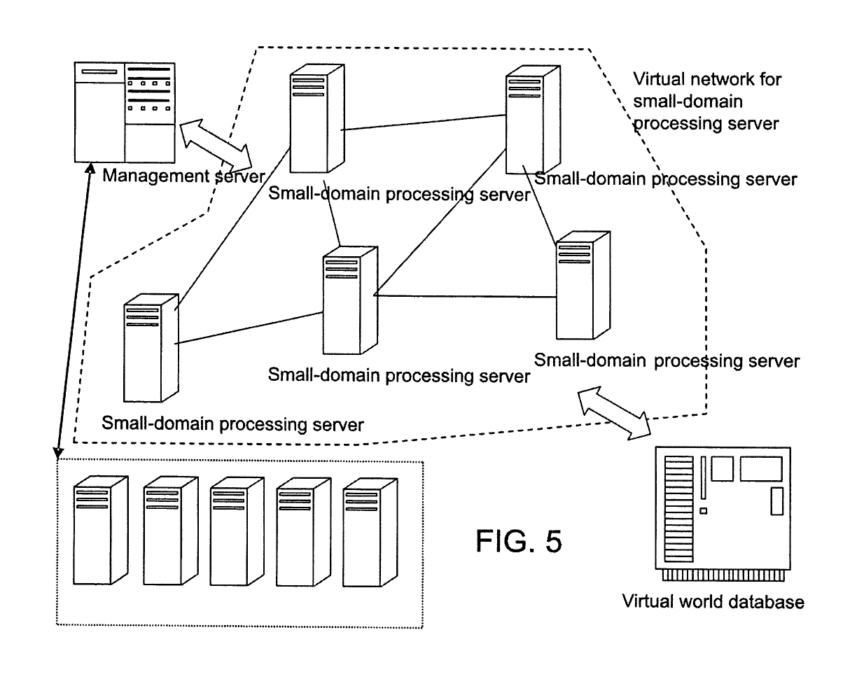

In addition, the data structure referred to here is not the data structure that each server processes for the virtual world, so the node does not include data for managing the virtual world such as objects or avatars. A management server for managing a small-domain server network (shown in FIG. 5) preserves the data structure. Each small-domain processing server has a copy of the node data of its management object and uses it for cooperating between small domain servers.

In exemplary embodiments, a node corresponds individually to a small-domain processing server (hereinafter, simply described as a ‘server’), and each node has an index of the corresponding server. Further, to preserve a topology with an adjacent node in the graph, the node has a list of edges that are connected with the node. Following the edge on the graph and using a server index corresponding to an adjacent node, the server can acquire and access server addresses and the like from the table. Each server connected by the line in the network drawing of the small-domain processing server (see FIG. 5) represents a server connected by the edge, and does not refer to a physical connection. By using the data structure of such a graph, a network is virtually formed to connect each server.

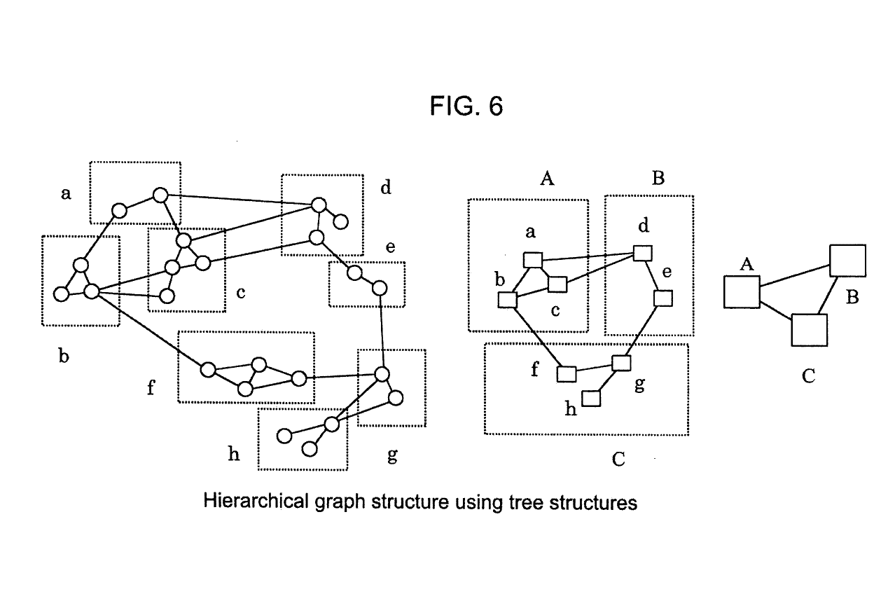

In addition, it is possible to divide a space in the node into a smaller space to preserve it as a graph. Thereby, when dynamically dividing a space, a design of how to divide it can be made in advance. A child graph is possessed as a tree structure and preserves two new nodes that are created at the time of dividing the nodes. The child data uses the same node data. FIG. 6 is an example of a hierarchical graph structure. The tree structure here is not a binary partition tree. By adopting the binary partition tree, node division can be easily processed.

In exemplary embodiments, an edge has a pointer to two pieces of node data, which becomes both points of the edge. Further, the edge (not the node) is made to include geometric information of the boundary part. Regarding geometric information, by causing a point to have a curved surface equation or plane expression, it is possible to ascertain whether the point exists on the side of node 1 or node 2 against a boundary; this is achieved through sign detection by substituting coordinates of the point into the curved surface equation or plane expression. That is, when a certain object and character move, it is possible to decide through using sign detection whether they go over the boundary. The boundary surface is actually made to be shared by the adjacent area with some degree of width, and is made to have some margin of the processing when moving between areas. (When going over to some degree, no movement is made between servers)

### Example of Dynamic Server Addition and Deletion

When considering a configuration of server group in virtual world, servers in the virtual world are largely classified into three server groups, as shown in FIG. 5: management servers, small-domain processing servers, and virtual world database.

The management server is a server for managing server groups in a virtual world, enabling the dynamic addition and deletion of on-demand small-domain servers according to the graph structure of the present invention. Further, the management server associates the client with the small-domain processing server. To manage the small-domain processing server, the management server has data of the graph structure according to the present invention.

The small-domain processing server is a server for processing events in a small domain, which is a divided virtual world. Input from a corresponded client, action of objects, etc., and interaction are calculated and processed in the small domain. The results are reflected in the database and a message is returned to the client for updating the display. In the data of the graph structure, the small-domain processing server has a copy of the node data corresponding to itself to exchange data with the adjacent small-domain processing server by following the edge data in the node.

The virtual world database manages data of objects and characters and the like in the virtual world. From the database, each small-domain processing server has a copy of object/character data, to be the management object of each and to update the database when data is updated.

The client is connected with the management server via a login server, and the management server selects a small-domain processing server, which is corresponded from coordinates (obtained from database) of a character operated by the client, to make the client associated with the small-domain server.

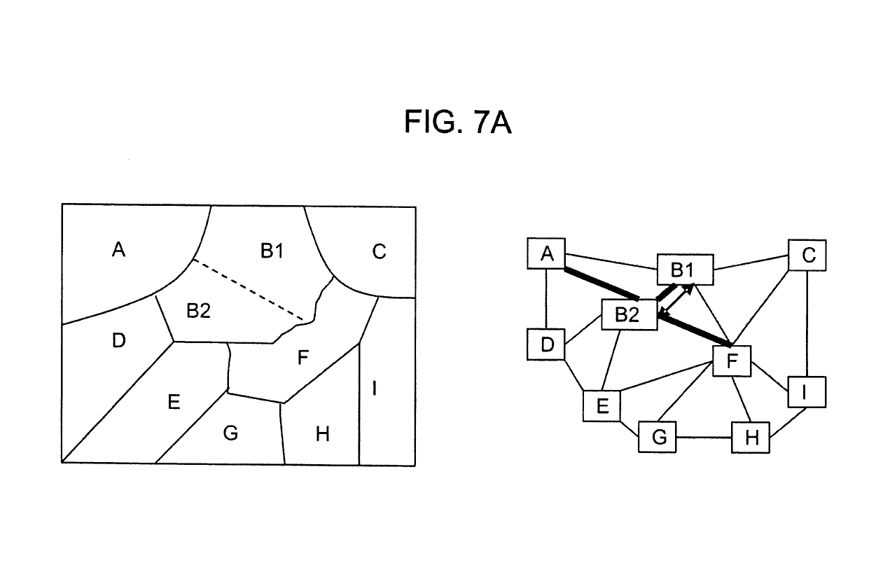

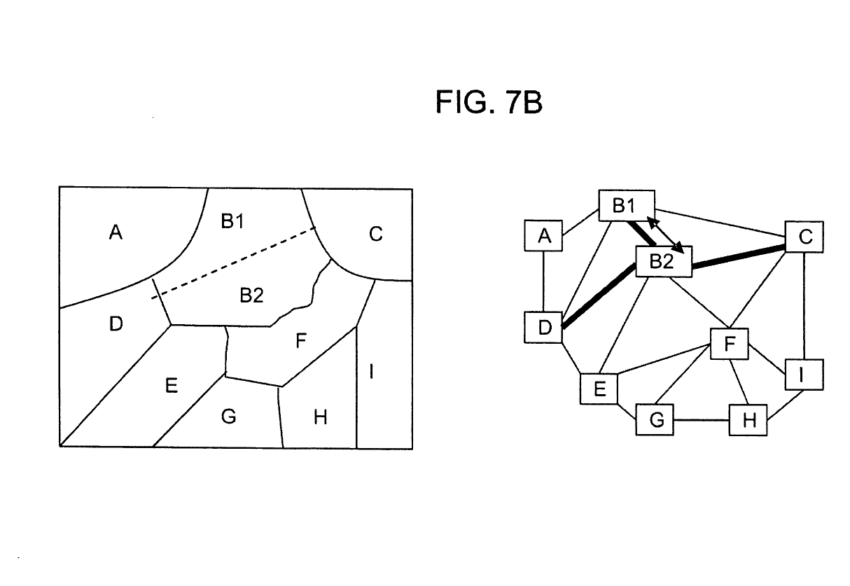

When adding a server, a small domain in the virtual world is divided into two and processing is dispersed between two servers. A node split operator is performed and nodes are then divided on the graph (as shown by FIG. 2a), so that one node is divided into two nodes and a new edge is generated in-between. The node split is not a uniquely defined topology operation on the graph. (FIG. 7)

In exemplary embodiments, to cause a node split on a graph to be a unique operation, two nodes have only to be designated for determining a position to insert an edge (other than the nodes to be divided). That is, in the upper example of FIG. 7, in addition to dividing node “B”, when nodes “A” and “F” are designated (which form a triangle with the edge to be inserted) a unique operation can be determined. In the same way, in the lower example of FIG. 7, node “B” (to be divided) and “C” and “D” are designated. At the time of space division, these two nodes correspond to the point at which boundary portions intersect. That is, based on geometric information, a unique graph operation can be determined.

In exemplary embodiments, by the node split, a new node and three edges are newly added. Three heavy lines shown in FIG. 7 are edges to be added: one is for connecting each divided node and the remaining two are edges to be connected with adjacent nodes, in common with nodes before division. The attribution of the first edge then has to be newly added; however, since originally one node is divided, it should be movable and visible, so that such attribution can be added automatically. Since the remaining two edges represent the same boundary as the node before division, original attribution of the edge and geometric data of the boundary have only to be copied. (In the upper drawing of FIG. 7, edges AB1/AB2 and FB1/FB2 have the same attribution data and geometric data). Further, among edges belonging to nodes before division, edges to be connected with a new node move to an edge list of the newly added node. Node information of the edge data then is updated.

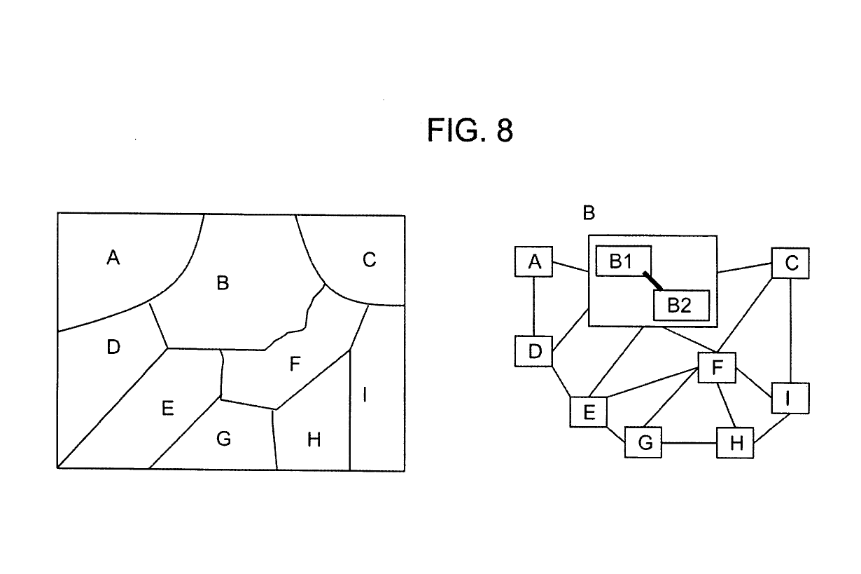

As for the processing of node split, if a child graph is defined in the node, the node is divided using the information. Without the child graph, a boundary going through the center of gravity of the node is obtained and is divided based on a geometric data node. When there is a child graph as per FIG. 8, the geometric data of the boundary and information of the two nodes necessary for division processing are stored (in advance) in the edge connecting each child node. The server associated to a parent node is copied to either of the child nodes, the edge list is transferred to the child node, and node information of the edge data is updated.

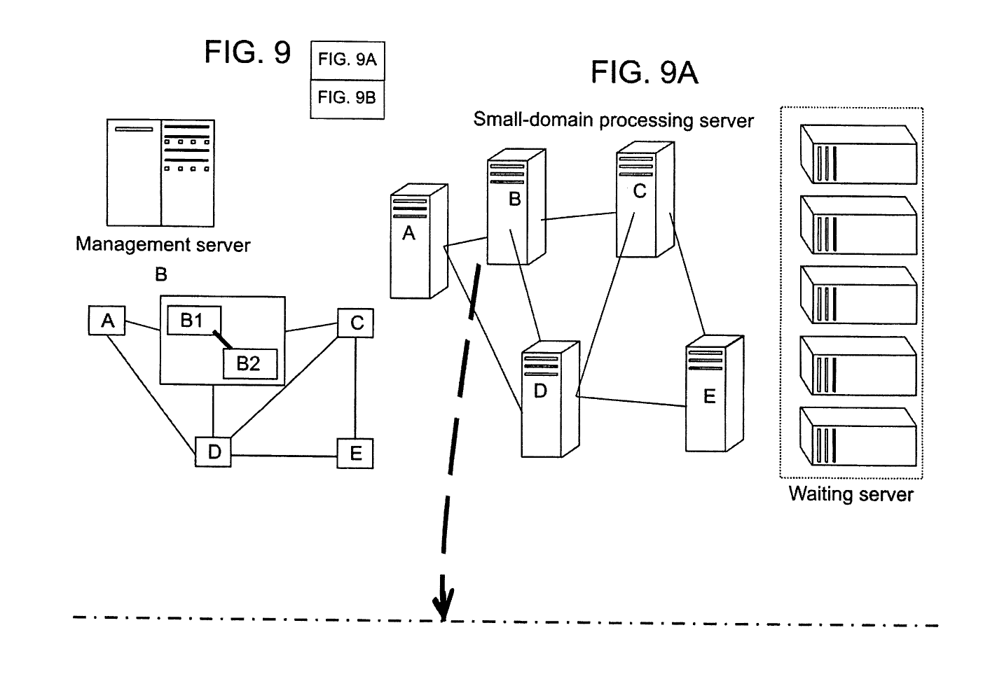

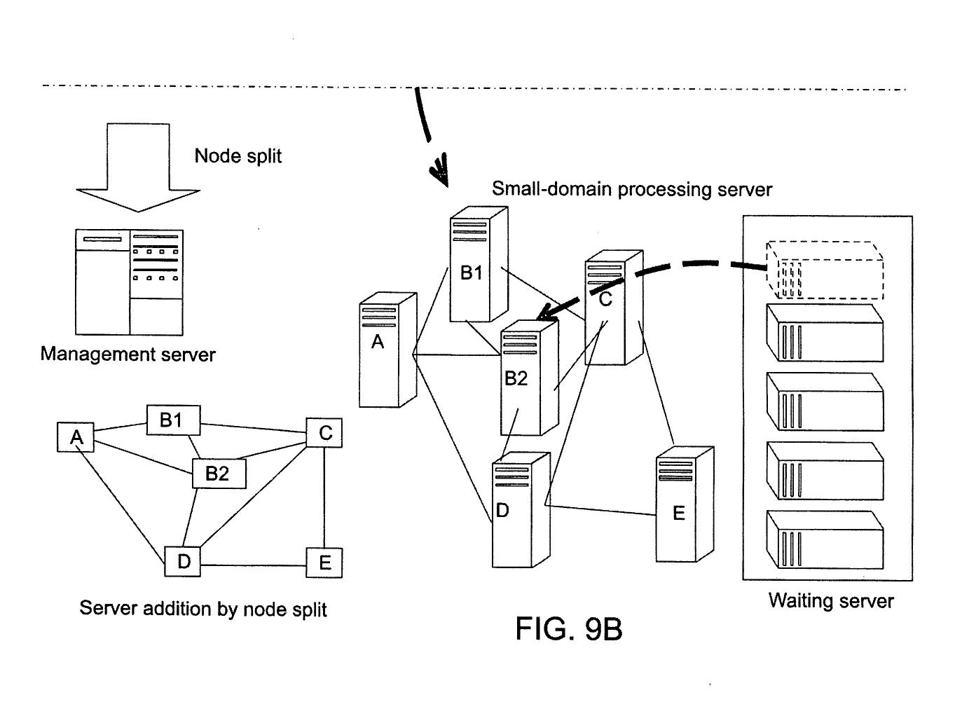

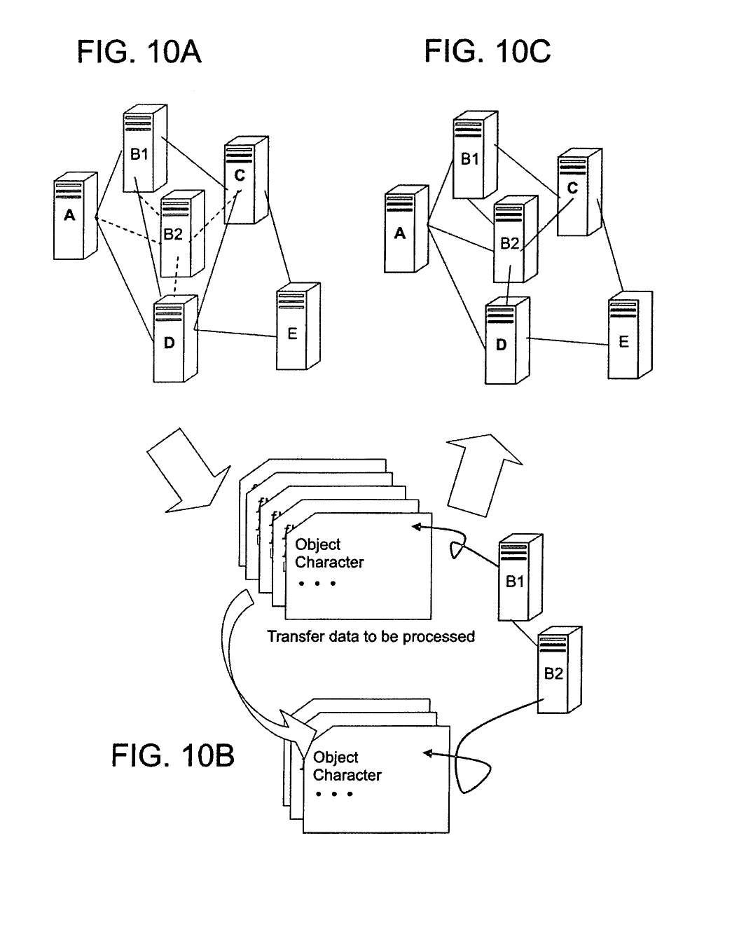

One server is newly allocated to a newly added node. As in FIG. 9, from the top of a waiting server queue, one server is selected, associated with a node, and added to a small-domain processing server network. The added server is made to have a copy of new node data and begins processing on the server. At this moment, no client (player character) or object is associated with the new server. A node adjoining to the node conducted node division with an edge is subjected to a change of graph topology. However, since at this point the newly added server is not prepared, by making data intact and behaving as if the network remains as it is until the new server is ready, the server can be added without stopping the processing. (See FIG. 10a)

When the server is ready, the coordinate value of a player character/object, etc., associated with an original server before division is subjected to sign detection with a boundary of a new edge, and those in the area of the new server are associated with the new server and transferred. (See FIG. 10b) When the transfer is completed, each server is synchronized, node data owned by a server corresponding to the adjoining node is updated, and a virtual network is formed and represented by new graph data. (See FIG. 10c)

When deleting a server, two small domains in the virtual world are integrated into one domain and the domain is processed by one server. On the graph (as per FIG. 2b) an edge contraction is performed and two nodes are integrated. The processing is uniquely determined on the graph.

Edge contraction is processing in which an edge is deleted, and nodes of both ends of the edge are also deleted and integrated into the other. From the edge list of the node on the side to be deleted, data of the edge is copied to the edge list of the other node to update node edge information. An edge then appears, having the same combination of nodes on both ends, so that edge data is deleted.

If there is a common parent node for the two nodes to be integrated, the parent node replaces the node after integration. (The edge to be condensed and node to be deleted are not actually deleted, but are recorded as child nodes). Further, it is specified that edges with nodes that have different parent nodes on both ends cannot be condensed.

When deleting the server, a reverse operation of adding the server is conducted. First, servers are synchronized and, as shown in FIG. 10c, node data owned by the server corresponding to the node adjacent to nodes B1 and B2 (of both ends of the edge to be condensed) is updated into the topology after the edge condensation. (To be placed under the conditions of FIG. 10a) Then, with the condensation of the edge, the player character/object, etc., is processed by the server associated with the node (B2 of FIG. 10) to be deleted, associated with the server corresponding to the other node, and finally transferred. After transferring all processing into the other server, the server to be deleted is loaded onto the waiting server queue and enters a waiting state.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In a distributed computer system having a plurality of servers, a method for a capacity on-demand server mechanism for generating seamless a 3D virtual world, the method consisting of:
determining a number of domains into which the 3D virtual world can be divided in response to an available number of servers in the distributed computer system to support the number of domains;
partitioning the 3D world into the domains;
associating each of the domains with a server in the distributed computer system;
relating each of the partitioned domains to nodes of a graph, wherein adjacent domains are connected by edges wherein data between connecting edges is exchanged, and wherein each edge include edge attributes defining a quality of the 3D virtual world;
in each of the servers associated with the domains, storing a list of edges adjacent the domain;
storing each list of edges associated with each of the servers in a central management server associated with the distributed computer system;
in response to a need to distribute the domains among the servers in the distributed computer system, performing a node split on one or more of the nodes by inserting an edge within each of the one or more nodes thereby splitting each of the one or more nodes;
in response to a need to place one or more servers in a stand-by mode, performing an edge contraction by merging two or more adjacent nodes;
transferring data among the domains in response to an interaction of an object in the 3D virtual world with one or more of the domains;
determining an effect in the one or more of the domains in response to the interaction of the object with the one or more of the domains;
determining a location of the object in the one or more of the domains by analyzing a pointer associated with each of the edges; and
updating each of the servers associated with the domains through which the object has interacted.
